(19) United States
(12) Patent Application Publication
(10) Pub. No.: US 2017/0041274 A1
(43) Pub. Date: Feb. 9, 2017

(54) Peer-augmented message transformation and disposition apparatus and method of operation

(71) Applicants: Lindsay Snider, Ann Arbor, MI (US); Guy Suter, Ann Arbor, MI (US); Ian Berry, Ann Arbor, MI (US)

(72) Inventors: Lindsay Snider, Ann Arbor, MI (US); Guy Suter, Ann Arbor, MI (US); Ian Berry, Ann Arbor, MI (US)

(21) Appl. No.: 14/819,025

(22) Filed: Aug. 5, 2015

(51) Int. Cl. H04L 12/58

(52) U.S. Cl. CPC H04L 51/28; H04L 51/16

(57) ABSTRACT

An apparatus imputes an indirect relationship between a message sender and recipient by transforming the relationships of intermediaries into a reputation. When at least one intermediary of a cohort has a direct relationship with a message sender and a direct relationship with a message recipient, sharing of the connections is obtained, measures are imputed to messages received by the recipient from the sender independent of any direct contact between the two. Average response time and response rate are examples of measures of a direct relationship between message clients. Permission-based connection sharing protects privacy and ensures that a reputation is derived from relationships that meet one or more minimum thresholds of measurements. Frequency, recency, quality, quantity, and symmetry are some of the dimensions that measure each relationship. An instrumented display apparatus, presents messages according to imputed relationship measures when direct relationship measures are insufficient.

### CROSS-REFERENCES TO RELATED APPLICATIONS

None.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Technical Field

Electronic messaging.

### Description of the Related Art

Well known electronic means for communication such as email messaging are multiplying by text, voice messaging, tweets, short message service (sms), images, photos, sounds, which result in overloading the recipients.

It is known that various methods and apparatus are available to determine and remove messages containing malicious content or unsolicited commercial messages. And these continue to improve in coverage which reduce unsought communication.

Even so, it is often difficult to prioritize the reading and response to received email that is all legitimate, well-intentioned, and proper. Some of the mail may require intervention or stimulate action on the part of the recipient, while most of it is merely documentary or informational.

A growing number of hours per day for each email user is being lost to read and dispose of automated email messages from legitimate commercial and social relationships. Each person has their own preferences on how to handle various types of messages.

A recipient of a message may have little positive history with the sender to influence or guide a proposed disposition. These senders may not share the same service provider, or LDAP, or enterprise and may come and go so that conventional authentication systems are inapplicable.

For the purpose of clarifying the invention within the disclosure we define certain terms:

Disposition of electronic communication is defined to include archiving a message, reading and forwarding a message to another recipient, reading and replying to the sender of a message, initiating an application, playing or attending to the message body, and deleting a message. Messages include other than email such as voice messages, SMS, faxes, multimedia messages, tweets, and feeds.

What is needed is a quicker and more personalized way for a message recipient to react to and dispose of messages from a sender by better using message histories.

In addition to relying solely on one's individual history with a sender, what is needed is a method to find a network effect in measuring a reputation of a sender among one's cohort of trusted recipients.

### BRIEF SUMMARY OF THE INVENTION

Electronic messages are organized for the benefit of each recipient. A relationship between the recipient and each sender is measured. A message display is transformed by the relationships.

We define recency as measured by the number of messages sent or received in the multiple 90 day periods preceding. The number is normalized according to the average traffic of the recipient in each period. Each 90 day period receives a maximum score. The scores of the multiple periods are weighted but not necessarily equally. Periods closer to the present have a greater influence on the measure. But longevity across many periods suggests a stronger relationship than one which is only trending. The result of the recency measure is a ranking in the display tool of the apparatus to enable more convenient access to messages from those senders with highest recency measurement.

An apparatus measures and records time to disposition and disposition of each message presented to a message recipient by a message sender and aspects of the thread of messages between the two.

A first circuit transforms a record of message exchanges between two parties and the dispositions of these messages by each party into measures of a direct relationship. These relationship measures change over time and control the display and predicted disposition of future messages received by each of the two parties.

A second circuit obtains permission from each party in a connection to share their relationship measures with other selected parties. The second circuit determines a cohort of intermediaries which link two unconnected parties. Each member of the cohort has a direct relationship with each of two unconnected parties.

A third circuit transforms relationship measures of two linked direct relationships by imputing relationship measures of an indirect relationship.

A fourth circuit transforms a plurality of relationship measures into a reputation measure.

A method of operation for an apparatus transforms a plurality of relationship measures into a reputation for a message sender.

An apparatus imputes an indirect relationship between a message sender and a message recipient by transforming the relationships of a cohort of intermediaries into a reputation. When at least one intermediary of a cohort has a first direct relationship with a message sender and a second direct relationship with a message recipient, and sharing of the connections is obtained, relationship measures are imputed to messages received by the recipient from the sender independent of any direct contact or history between the two. Average response time and average response rate are examples of measures of a direct relationship between a pair of message clients. Permission-based connection sharing protects privacy and ensures that a reputation is derived from relationships that meet one or more minimum thresholds of measurements. Frequency, recency, quality, quantity, and symmetry are some of the dimensions that measure each relationship. An instrumented display apparatus captures measures of message disposition by each recipient and in turn, presents messages according to imputed relationship measures.

A system records message traffic for each sender-receiver connection. A recipient's disposition of each message influences the presentation of future messages from each sender. The patterns of messages and dispositions are transformed into measures of each relationship. A message sender may have a reputation among a cohort of recipients. The system improves the efficiency of a message recipient by presenting messages in a way that is influenced by the message senders' reputation and relationship to the recipient.

### BRIEF DESCRIPTION OF THE SEVERAL VIEWS OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of a processor suitable for performance of the claimed method steps;

FIG. 2 is a block diagram of a system;

FIG. 3 is a block diagram of a apparatus embodiment;

FIG. 4 is a flowchart of a method for performing process steps; and

FIG. 5 is an illustration non-transitory media on which is encoded types of records of messages and disposition of messages transformed by the apparatus.

### DETAILED DISCLOSURE OF EMBODIMENTS OF THE INVENTION

One aspect of the invention is a system having: at least one message server; a plurality of message senders and recipients; an instrumented display for capturing and storing measures of message exchanges and permission to share measures; an apparatus to anticipate a message recipient's disposition according to a relationship with a message sender; an apparatus to transform measures of direct relationships to impute measures for an indirect relationship; and an apparatus to transform direct relationship measures of a cohort into a reputation of a sender connected to each member of the cohort.

Another aspect of the invention is a message transformation apparatus having: a circuit to record and store aspects of messages exchanged as direct relationship measures; a circuit to obtain permission to share relationship measures; and a circuit to transform a first direct relationship measure and a second direct relationship measure into an indirect relationship measure.

In an embodiment, the invention also has a circuit to transform a plurality of direct relationship measures into a reputation measure.

In an embodiment, the invention also has a display to present most likely message dispositions and record time to disposition and recipient's selected message disposition.

In an embodiment, an aspect of messages includes frequency of message exchanges.

In an embodiment, an aspect of messages includes likelihood of a reply to a message from a sender.

In an embodiment, the invention also has a circuit to infer a sentiment or quality from message content.

In an embodiment, the invention also has a circuit to determine delay and asymmetry in replies to a message sender.

In an embodiment, relationship measures include frequency, quantity, quality, duration, and recency.

In an embodiment, said transformations provide likelihood of reply, average time to reply, relationship symmetry characteristics, predicted disposition, and annotation on which messages are waiting for a reply.

Another aspect of the invention is a method for operation of a reputation server to assist a recipient to efficiently operate on received messages including the steps: obtaining permission from at least one member of a cohort to share relationship measures of a 1st direct relationship connecting said member and a message sender and a 2nd direct relationship connecting said member and a message recipient; receiving, measuring, and storing records of messages and dispositions of messages (records) exchanged between a 1st party and a plurality of other parties with whom 1st party has a direct connection; transforming said records into measures of a direct relationship between any two directly connected parties; and transforming relationship measures of a 1st direct relationship and relationship measures of a 2nd direct relationship to impute a relationship measure of an indirect relationship between parties linked by the 1st and 2nd direct relationships.

In an embodiment, the method also includes transforming relationship measures of each member of a cohort into a message sender reputation.

In an embodiment of the method, records of messages and dispositions of messages comprise the number of messages received from a sender and the number of messages replied to, and the time-to-disposition.

In an embodiment of the method, records of messages comprise the quality of messages according to content analysis of the body of the message and the reply-to address.

In an embodiment of the method, records of messages comprise the inter-arrival time of messages from a sender over periods of history.

In an embodiment of the method, records of messages comprise the normalized delay in receiving a reply message.

In an embodiment of the method, records of messages comprise the normalized strength of a relationship.

In an embodiment of the method, records of messages comprise the recipient receiving a message as a copy, a member of a list, or directly as the mail-to addressee.

In an embodiment of the method, a record of messages comprise a duration of a relationship and the recency of latest message exchange.

In an embodiment of the method, a record of messages comprise a quantity, symmetry, and frequency of message exchanges.

An apparatus imputes an indirect relationship between a message sender and a message recipient by transforming the relationships of a cohort of intermediaries into a reputation. This depends on both user agreement, and selection of useful members of a cohort. Not every relationship has equal value.

When at least one intermediary of a cohort has a first direct relationship with a message sender and a second direct relationship with a message recipient, and sharing of the connections is obtained, relationship measures are imputed to messages received by the recipient from the sender independent of any direct contact or history between the two. In some cases, a strong indication from the cohort may override a poor direct relationship.

Average response time and average response rate are examples of measures of a direct relationship between a pair of message clients. A condition of waiting for a response can be determined for a transmitted message.

Permission-based connection sharing protects privacy and ensures that a reputation is derived from relationships that meet one or more minimum thresholds of measurements. Connections with some senders may be selected in or out by name or by the class of the relationship.

Frequency, recency, quality, quantity, and symmetry are some of the dimensions that measure each relationship. Duration of a long standing relationship may counter an absence of recent interaction.

An instrumented display apparatus captures measures of message disposition by each recipient and in turn, presents messages according to imputed relationship measures. If the predicted disposition is correct, acceptance minimizes the number of steps or interactions to accept.

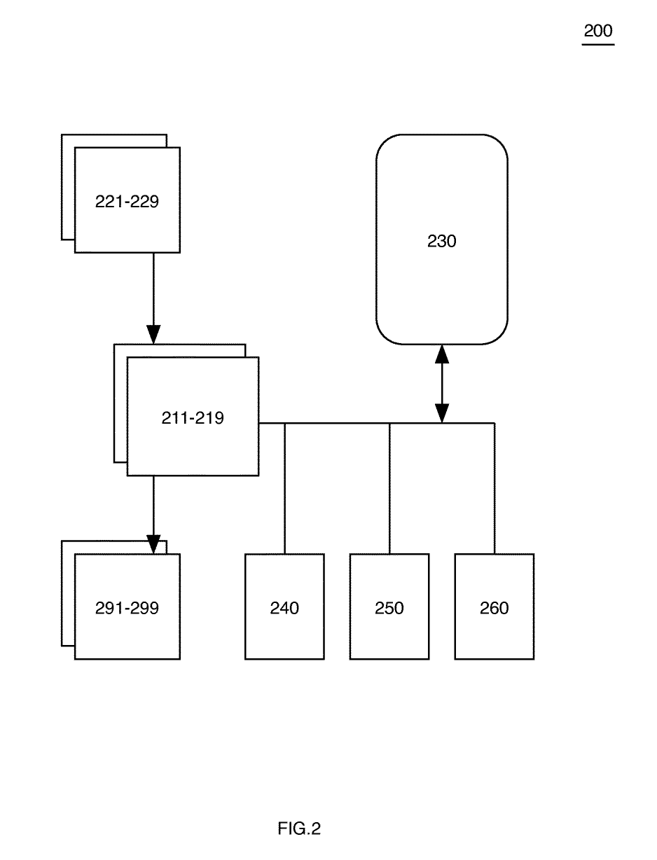

In FIG. 2 a system 200 includes at least one message server 211-219 coupled to a plurality of message senders 221-229 and recipients 291-299; an instrumented display 230 for capturing and storing measures of message exchanges and permission to share measures; an apparatus to anticipate a message recipient's disposition according to a relationship with a message sender 240; an apparatus to transform measures of direct relationships to impute measures for an indirect relationship 250; and an apparatus to transform direct relationship measures of a cohort into a reputation of a sender connected to each member of the cohort 260.

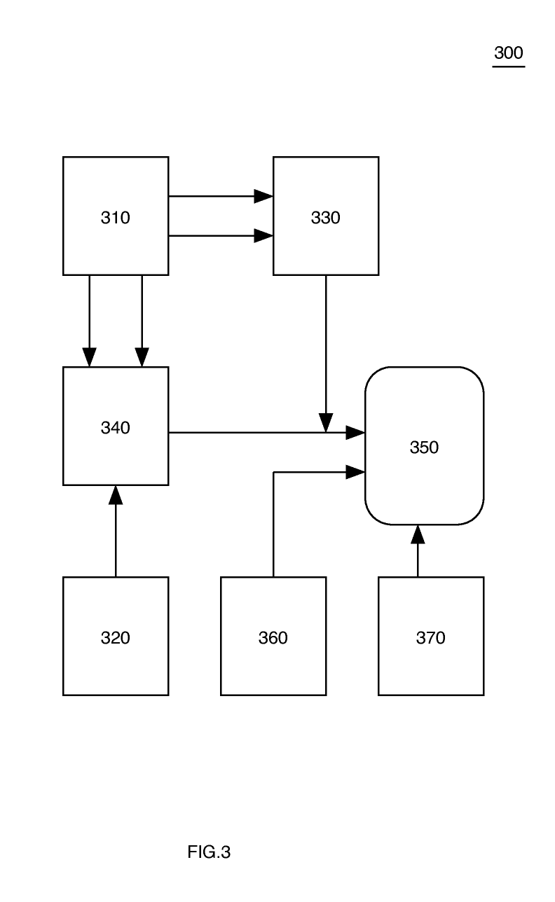

In FIG. 3 a message transformation apparatus 300 includes a circuit to record and store aspects of messages exchanged as direct relationship measures 310; a circuit to obtain permission to share relationship measures 320; and a circuit to transform a first direct relationship measure and a second direct relationship measure into an indirect relationship measure 330. The apparatus also has a circuit to transform a plurality of direct relationship measures into a reputation measure 340. Both relationship measures and reputation measures control a display to present most likely message dispositions and record time to disposition and recipient's selected message disposition 350; a circuit to infer a sentiment or quality from a message content 360; and a circuit to determine delay and asymmetry in replies to a message sender 370.

The apparatus determines and stores relationship measures including frequency, quantity, quality, duration, and recency. The measures are transformed by the apparatus to provide likelihood of reply, average time to reply, relationship symmetry characteristics, predicted disposition, and annotation on which messages are waiting for a reply.

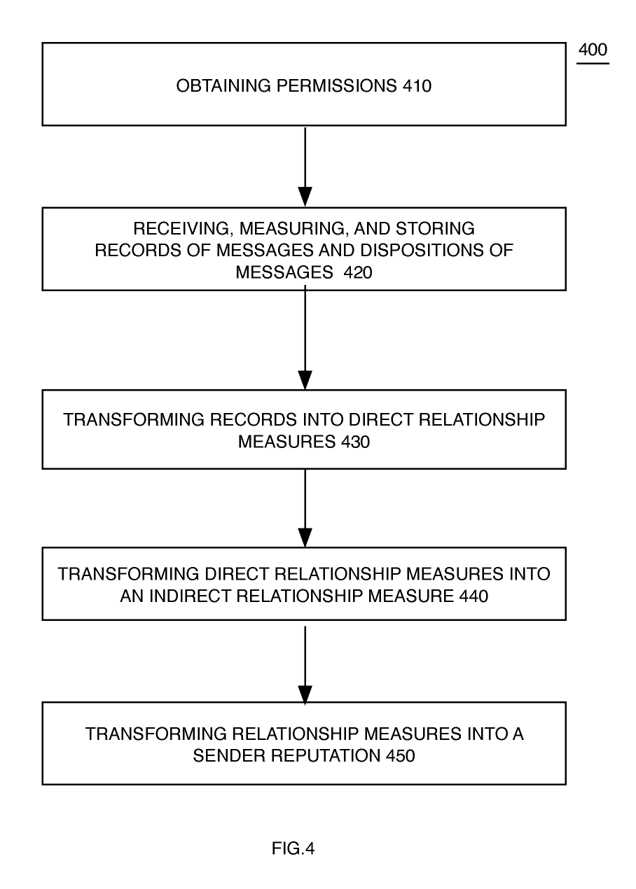

In FIG. 4, a method for operation of a reputation server to assist a recipient to efficiently operate on received messages includes the process steps: obtaining permission from at least one member of a cohort to share relationship measures of a 1st direct relationship connecting said member and a message sender and a 2nd direct relationship connecting said member and a message recipient 410; receiving, measuring, and storing records of messages and dispositions of messages (records) exchanged between a 1st party and a plurality of other parties with whom 1st party has a direct connection 420; transforming said records into measures of a direct relationship between any two directly connected parties 430; and transforming relationship measures of a 1st direct relationship and relationship measures of a 2nd direct relationship to impute a relationship measure of an indirect relationship between parties linked by the 1st and 2nd direct relationships 440; and transforming relationship measures of each member of a cohort into a message sender reputation 450.

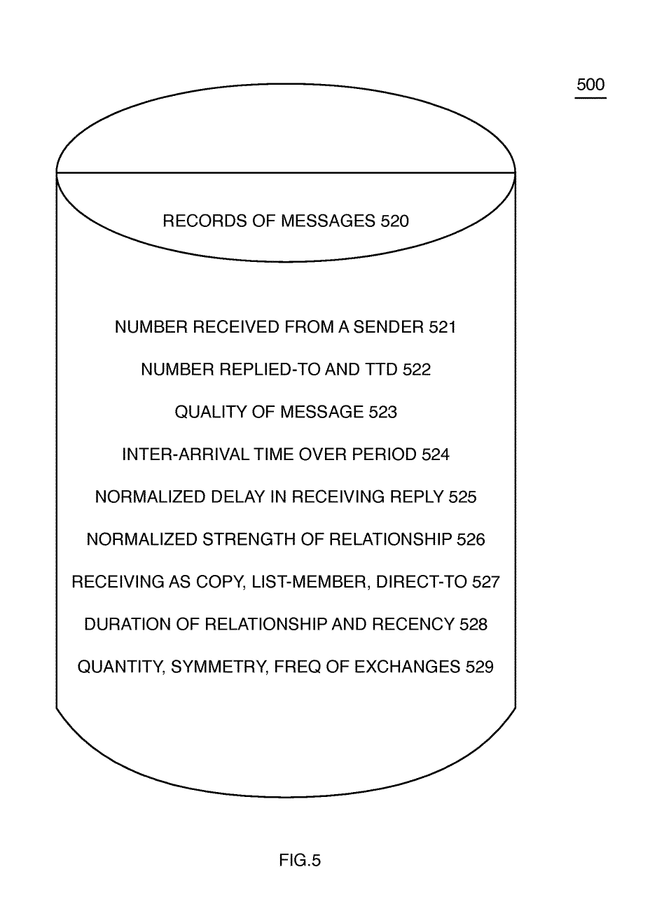

In FIG. 5 a non-transitory store contains records of messages and dispositions of messages. These records include the number of messages received from a sender and the number of messages replied to, and the time-to-disposition; the quality of messages according to content analysis of the body of the message and the reply-to address; the inter-arrival time of messages from a sender over periods of history; the normalized delay in receiving a reply message; the normalized strength of a relationship; the recipient receiving a message as a copy, a member of a list, or directly as the mail-to addressee; a duration of a relationship and the recency of latest message exchange; and a quantity, symmetry, and frequency of message exchanges.

### CONCLUSION

The invention can be easily distinguished from email filters which depend on content analysis of the message body.

The invention can be easily distinguished from email filters which depend on black lists or white lists.

The invention can be easily distinguished from email filters which depend on block lists.

The invention can be easily distinguished from attempts to validate SMTP header fields or apply policies to attack sender spoofing.

The invention can be easily distinguished by its recordation of dispositions by at least one message recipient.

The techniques described herein can be implemented in digital electronic circuitry, or in computer hardware, firmware, software, or in combinations of them. The techniques can be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; internal hard disks or removable disks. The processor and the memory can be supplemented by, or incorporated in special purpose logic circuitry.

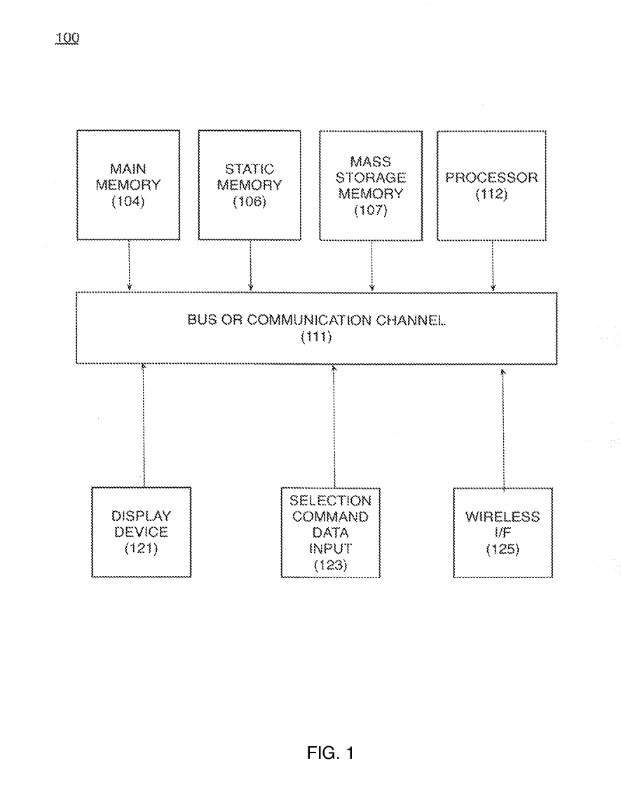

An exemplary processor suitable for performance of the method steps and transformations is shown in FIG. 1 in which an exemplary programmable processor comprising a bus or communication channel 111 coupling main memory 104, static memory 106, mass storage memory 107, and a processor circuit 112 for executing instructions, and in embodiments at least one interface to couple a display device 121, a selection command data input 123, and/or a wireless interface 125.

A number of embodiments of the invention have been described. Nevertheless, it will be understood that various modifications may be made without departing from the spirit and scope of the invention. For example, other network topologies may be used. Accordingly, other embodiments are within the scope of the following claims.

1. A system comprising:
at least one message server;
a plurality of message senders and recipients;
an instrumented display for capturing and storing measures of message exchanges and permission to share measures;
an apparatus to anticipate a message recipient's disposition according to a relationship with a message sender;
an apparatus to transform measures of direct relationships to impute measures for an indirect relationship; and
an apparatus to transform direct relationship measures of a cohort into a reputation of a sender connected to each member of the cohort.

2. A message transformation apparatus comprising:
a circuit to record and store aspects of messages exchanged as direct relationship measures;
a circuit to obtain permission to share relationship measures; and
a circuit to transform a first direct relationship measure and a second direct relationship measure into an indirect relationship measure.

3. The apparatus of claim 2 further comprising:
a circuit to transform a plurality of direct relationship measures into a reputation measure.

4. The apparatus of claim 2 further comprising:
a display to present most likely message dispositions and record time to disposition and recipient's selected message disposition.

5. The apparatus of claim 2 wherein an aspect of messages comprise:
frequency of message exchanges.

6. The apparatus of claim 2 wherein an aspect of messages comprise:
likelihood of a reply to a message from a sender.

7. The apparatus of claim 2 further comprising:
a circuit to infer a sentiment or quality from a message content.

8. The apparatus of claim 2 further comprising:
a circuit to determine delay and asymmetry in replies to a message sender.

9. The apparatus of claim 2 wherein:
relationship measures comprise frequency, quantity, quality, duration, and recency.

10. The apparatus of claim 2 wherein:
said transformations provide likelihood of reply, average time to reply, relationship symmetry characteristics, predicted disposition, and annotation on which messages are waiting for a reply.

11. A method for operation of a reputation server to assist a recipient to efficiently operate on received messages comprising:
obtaining permission from at least one member of a cohort to share relationship measures of a 1^{st} direct relationship connecting said member and a message sender and a 2^{nd} direct relationship connecting said member and a message recipient;
receiving, measuring, and storing records of messages and dispositions of messages (records) exchanged between a 1^{st} party and a plurality of other parties with whom 1^{st} party has a direct connection;
transforming said records into measures of a direct relationship between any two directly connected parties; and
transforming relationship measures of a 1^{st} direct relationship and relationship measures of a 2^{nd} direct relationship to impute a relationship measure of an indirect relationship between parties linked by the 1^{st} and 2^{nd} direct relationships.

12. The method of claim 11 further comprising:
transforming relationship measures of each member of a cohort into a message sender reputation.

13. The method of claim 11 wherein
records of messages and dispositions of messages comprise the number of messages received from a sender and the number of messages replied to, and the time-to-disposition.

14. The method of claim 11 wherein
records of messages comprise the quality of messages according to content analysis of the body of the message and the reply-to address.

15. The method of claim 11 wherein
records of messages comprise the inter-arrival time of messages from a sender over periods of history.

16. The method of claim 11 wherein
records of messages comprise the normalized delay in receiving a reply message.

17. The method of claim 11 wherein
records of messages comprise the normalized strength of a relationship.

18. The method of claim 11 wherein
records of messages comprise the recipient receiving a message as a copy, a member of a list, or directly as the mail-to addressee.

19. The method of claim 11 wherein
a record of messages comprise a duration of a relationship and the recency of latest message exchange.

20. The method of claim 11 wherein
a record of messages comprise a quantity, symmetry, and frequency of message exchanges.
